(19) United States
(12) Patent Application Publication
(10) Pub. No.: US 2005/0222756 A1
(43) Pub. Date: Oct. 6, 2005

(54) Methods for displaying a route traveled by mobile users in a communication network

(76) Inventors: Scott B. Davis, Walworth, WI (US); Raymond L. Sokola, Long Grove, IL (US); Michael A. Newell, Williams Bay, WI (US); Robert F. D'Avello, Lake Zurich, IL (US); Nick J. Grivas, Harvard, IL (US); Jerome D. Meyerhoff, Buffalo Grove, IL (US); James A. Van Bosch, Crystal Lake, IL (US)

Correspondence Address: MOTOROLA, INC., 1303 EAST ALGONQUIN ROAD, IL01/3RD, SCHAUMBURG, IL, 60196, US

(21) Appl. No.: 10/818,000

(22) Filed: Apr. 5, 2004

(51) Int. Cl. G01C 22/00

(52) U.S. Cl. 701/205; 701/200

(57) ABSTRACT

An improved system and procedure for allowing a user to post a route to another mobile user or to himself. In one embodiment, a user engages his user interface to record and transmit the traveled route to a second user or to himself at a later time. The recipient receives the route in accordance with his user ID and other parameters specified or messages left by the initiating user. The route can be displayed on a map, in text, or audibly broadcast. In an alternative embodiment, the route can be left by a non-mobile user for the benefit of a mobile user using, for example, a home computer.

The present application is related to the following co-pending, commonly assigned patent applications, which were filed concurrently herewith and incorporated by reference in their entirety:
Ser. No. ______, entitled “Selectively Enabling Communications at a User Interface Using a Profile,” attorney docket TC00167, filed concurrently herewith.
Ser. No. ______,entitled “Method for Enabling Communications Dependent on User Location, User-Specified Location, or Orientation,” attorney docket TC00168, filed concurrently herewith.
Ser. No. ______, entitled “Methods for Sending Messages Based on the Location of Mobile Users in a Communication Network,” attorney docket TC00169, filed concurrently herewith.
Ser. No. ______,entitled “Conversion of Calls from an Ad Hoc Communication Network,” attorney docket TC00172, filed concurrently herewith.
Ser. No. ______, entitled “Method for Entering a Personalized Communication Profile Into a Communication User Interface,” attorney docket TC00173, filed concurrently herewith.
Ser. No. ______, entitled “Methods and Systems for Controlling Communications in an Ad Hoc Communication Network,” attorney docket TC00174, filed concurrently herewith.
Ser. No. ______, entitled “Methods for Controlling Processing of Inputs to a Vehicle Wireless Communication Interface,” attorney docket TC00175, filed concurrently herewith.
Ser. No. ______, entitled “Methods for Controlling Processing of Outputs to a Vehicle Wireless Communication Interface,” attorney docket TC00176, filed concurrently herewith.
Ser. No. ______, entitled “Programmable Foot Switch Useable in a Communications User Interface in a Vehicle,” attorney docket TC00177, filed concurrently herewith.

### FIELD OF THE INVENTION

This invention relates to a system and methods for sending and receiving routes in a communication network.

### BACKGROUND OF THE INVENTION

Communication systems, and especially wireless communication systems, are becoming more sophisticated, offering consumers improved functionality to communicate with one another. Such increased functionality has been particularly useful in the automotive arena, and vehicles are now being equipped with communication systems with improved audio (voice) wireless communication capabilities. For example, On Starm is a well-known communication system currently employed in vehicles, and allows vehicle occupants to establish a telephone call with others (such as a service center) by activating a switch.

It is also known in administrative systems that communicate with vehicles to include central terminals that can track the progress or route of a particular user or vehicle. For example, in U.S. patent application Ser. No. 09/995,231 (published as 2003/0100326), a dispatch system is disclosed in which the traveled routes of various emergency response vehicles coupled to the communication system (police, emergency vehicles, etc.) can be displayed at an administrator's terminal.

However, this application does not disclose or suggest sending a traveled route to a particular user coupled to the communications system. Instead, the routes are simply automatically broadcasted from members in a group. But this is not always acceptable. For example, in typical commercial vehicle-based communication system, many members (perhaps hundreds) may be logged into the system at one time. However, a particular member may be interested in only sharing route information with one particular other user, such as his spouse, friend, or business associate. In this regard, sharing of route information traveled by the user can be of great utility to those particular other users, but of course would not be of benefit to all other users communicating with the system. For example, the user may wish to display the route he has traveled to a restaurant so that his wife can join him for dinner; or he can leave a route traveled from the airport to a business meeting so that his business associates can later join him. Moreover, the user may also find benefit in leaving route information for himself. For example, suppose the user is out of town on business, and wishes to attend a dinner function distant from his hotel. The user may wish to capture the route traveled to the dinner function so that that route can be followed backward by the user to later find his hotel.

It would thus be convenient for vehicle-based (or other) communication systems to allow such traveled routes of a first user to be stored and transmitted to other specified system users or to the first user. Moreover, there is a need for such communication systems to further include the flexibility to allow a user to dynamically create, store, and transmit such traveled routes. This disclosure presents several different means for doing this.

It is, therefore, desirable to provide an improved procedure for sending and receiving routes in a communication network.

### BRIEF DESCRIPTION OF THE DRAWINGS

FIG. 1 is a block diagram of a wireless vehicular communications system;

FIG. 2 is a block diagram of a control system for a vehicular wireless communications system;

FIG. 3 is diagram illustrating a route traveled by a first vehicle and illustrating methods for designating locations along the route;

FIGS. 4a-4b are embodiments of a user interface for posting a route to another system user;

FIG. 5 is a diagram illustrating two vehicles in wireless communication and the transmission and storage of a route from one vehicle to the other;

FIGS. 6a-6b are some embodiments of methods for displaying the route transmitted to the recipient vehicle; and

FIG. 7 is a diagram illustrating one method for posting a route to a mobile user from a home computer.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the appended claims.

### DETAILED DESCRIPTION

What is described is an improved system and method for sending and receiving routes in a communication network. In one embodiment, a user engages his user interface to record and transmit the traveled route to a second user or to himself at a later time. The recipient receives the route in accordance with his user ID and other parameters specified or messages left by the initiating user. The route can be displayed on a map, in text, or audibly broadcast. In an alternative embodiment, the route can be left by a non-mobile user for the benefit of a mobile user using, for example, a home computer.

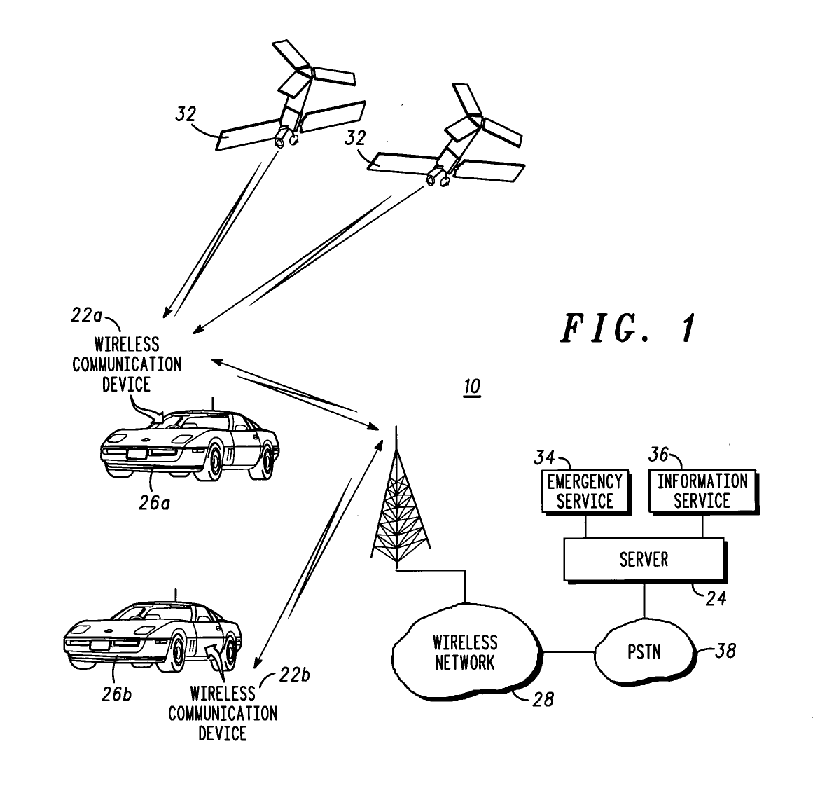

Now, turning to the drawings, an example use of the present invention in an automotive setting will be explained. FIG. 1 shows an exemplary vehicle-based communication system 10. In this system, vehicles 26 are equipped with wireless communication devices 22, which will be described in further detail below. The communication device 22 is capable of sending and receiving voice (i.e., speech), data (such as textual or SMS data), and/or video. Thus, device 22 can wirelessly transmit or receive any of these types of information to a transceiver or base station coupled to a wireless network 28. Moreover, the wireless communication device may receive information from satellite communications. Ultimately, the network may be coupled to a public switched telephone network (PSTN) 38, the Internet, or other communication network on route to a server 24, which ultimately acts as the host for communications on the communication system 10 and may comprise a communications server. As well as administering communications between vehicles 26 wirelessly connected to the system, the server 24 can be part of a service center that provides other services to the vehicles 26, such as emergency services 34 or other information services 36 (such as restaurant services, directory assistance, etc.).

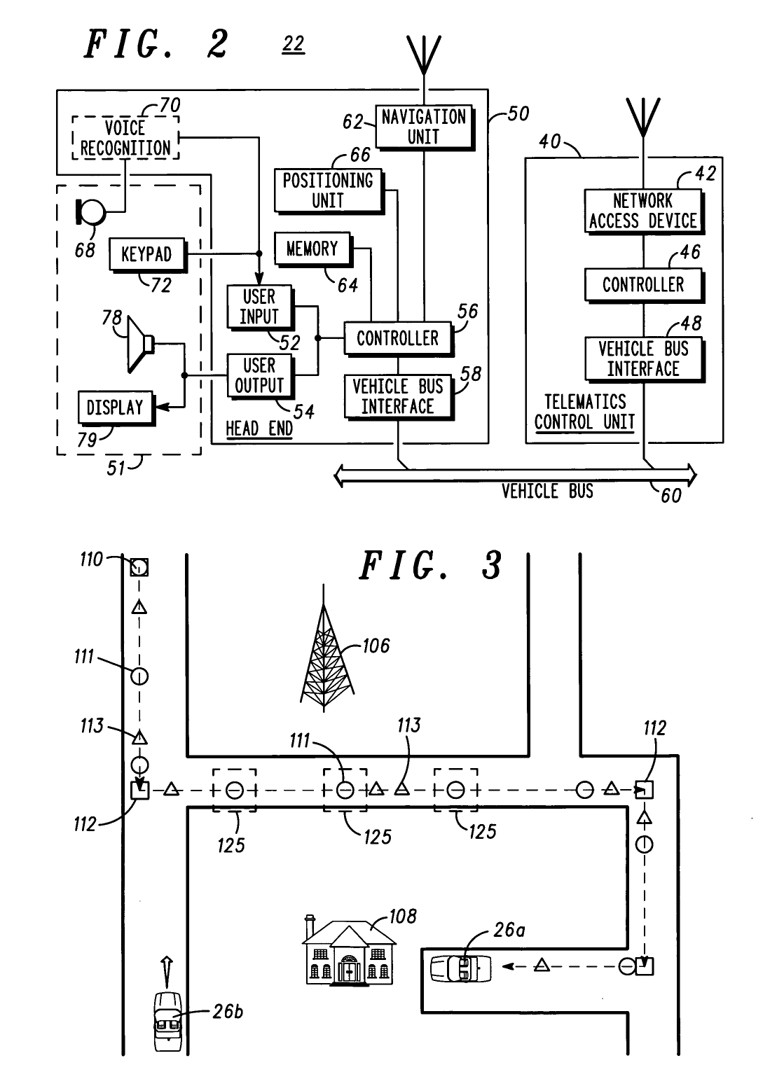

Further details of a typical wireless communications device 22 as employed in a vehicle 26 are shown in FIG. 2. In one embodiment, the device 22 is comprised of two main components: a head unit 50 and a Telematics control unit 40. The head unit 50 interfaces with or includes a user interface 51 with which the vehicle occupants interact when communicating with the system 10 or other vehicles coupled to the system. For example, a microphone 68 can be used to pick up a speaker's voice in the vehicle, and/or possibly to give commands to the head unit 50 if it is equipped with a voice recognition module 70. A keypad 72 may also be used to provide user input, with switches on the keypad 72 either being dedicated to particular functions (such as a push-to-talk switch, a switch to receive mapping information, etc.) or allowing for selection of options that the user interface provides.

The head unit 50 also comprises a navigation unit 62, which typically includes a Global Positioning Satellite (GPS) system for allowing the vehicle's location to be pinpointed, which is useful, for example, in associating the vehicle's location with mapping information the system provides. As is known, such a navigation unit communicates with GPS satellites (such as satellites 32) via a receiver. Also present is a positioning unit 66, which determines the direction in which the vehicle is pointing (north, north-east, etc.), and which is also useful for mapping a vehicle's progress along a route.

Ultimately, user and system inputs are processed by a controller 56 which executes processes in the head unit 50 accordingly, and provides outputs 54 to the occupants in the vehicle, such as through a speaker 78 or a display 79 coupled to the head unit 50. The speakers 78 employed can be the audio (radio) speakers normally present in the vehicle, of which there are typically four or more, although only one is shown for convenience. Moreover, in an alternative embodiment, the output 54 may include a text to speech converter to provide the option to hear an audible output of any text that is contained in a group communication channel that the user may be monitoring. This audio feature may be particular advantageous in the mobile environment where the user is operating a vehicle. Additionally, a memory 64 is coupled to the controller 56 to assist it in performing regulation of the inputs and outputs to the system. The controller 56 also communicates via a vehicle bus interface 58 to a vehicle bus 60, which carries communication information and other vehicle operational data throughout the vehicle.

The Telematics control unit 40 is similarly coupled to the vehicle bus 60, via a vehicle bus interface 48, and hence the head unit 50. The Telematics control unit 40 is essentially responsible for sending and receiving voice or data communications to and from the vehicle, i.e., wirelessly to and from the rest of the communications system 10. As such, it comprises a Telematics controller 46 to organize such communications, and a network access device (NAD) 42 which include a wireless transceiver. Although shown as separate components, one skilled in the art will recognize that aspects of the head unit 50 and the Telematics control unit 40, and components thereof, can be combined or swapped.

The wireless communications device 22 can provide a great deal of communicative flexibility within vehicle 26. For example, an occupant in a first vehicle 26a can call a second vehicle 26b to speak to its occupants either by pressing a switch on the keypad 72 of the head unit 50 or by simply speaking if the head unit is equipped with a voice recognition module 70. In one embodiment, the pressing of a switch or speaking into a voice recognition module initiates a cellular telephone call with a second vehicle 26b. In this case, users in either the first vehicle 26a or the second vehicle 26b can speak with each other without pressing any further switches. Moreover, the system may be configured to include a voice activated circuit such as a voice activated switch (VAS) or voice operated transmit (VOX). This would also provide for hands-free operation of the system by a user when communicating with other users.

In an alternative embodiment, the switch may be configured to establish a push-to-talk communication channel over a cellular network. Here, the controller 56 is configured to only allow audio by occupants in the first vehicle 26a through microphone 68 to be transmitted through the Telematics control unit 40 when a user in the first vehicle 26a is pressing down on the push-to-talk switch. The controller 56 is further configured to only allow audio received from the second vehicle 26b (or server 24) to be heard over speakers 78 when the operator of the first vehicle 26a is not pressing down on the switch. Alternatively, to avoid the need of holding down a switch to speak, the system may be configured to allow a user to push a button a first time to transmit audio and push the button a second time to receive audio.

In any event, a user in the second vehicle 26b can, in like fashion, communicate back to the first vehicle 26a, with the speaker's voice being heard on speaker(s) 78 in the first vehicle. Or, an occupant in the first vehicle 26a can call the server 24 to receive services. Additionally, such a system 10 can have utility outside of the context of vehicle-based applications, and specifically can have utility with respect to other portable devices (cell phones, personal data assistants (PDAs), etc.). The use of the system in the context of vehicular communications is therefore merely exemplary.

FIG. 3 illustrates two traveling vehicles 26a and 26b in communication with a transceiver tower or base station 106 which forms part of the communications system 10. Both vehicles have a user interface 51 as described earlier. In this embodiment, the first vehicle 26a has arrived at a destination 108 and wishes to record and send the route he has traveled to the second vehicle 26b, so that the second vehicle 26b can follow that route to meet the first vehicle 26a and/or to find the destination 108.

The locations of vehicles 26a and 26b (and any other users connected to the system 10) are tracked by the server 24. In this regard, the Telematics control unit 40 automatically transmits to the server 24 the information regarding the location (e.g., longitude/latitude) and identity of the vehicles on a periodic basis. Location information is provided by the navigation unit 62 (FIG. 2). Identity information can constitute a user ID for the user in the first vehicle who is logged on to the system, such as is disclosed in U.S. patent application Ser. No. [______], entitled “Methods for Sending Messages Based on the Location of Mobile Users in a Communication Network” [Attorney Docket TC00169], which is filed concurrently herewith and which is incorporated herein by reference in its entirety, or a phone number, a “handle,” a Vehicle Identification number (VIN), an Electronic Serial Number (ESN), an International Mobile Subscriber Number (IMSI), or a Mobile Subscriber International ISDN Number (MSISDN) as noted earlier. Alternatively, the controller 56 can cause the navigation unit 62 to send location and identity information concerning a given vehicle on a user-specified basis.

When wirelessly transmitting to the server 24, location and identity information for a particular vehicle may be formatted in any number of ways. For example, a header containing such information may be employed in a predictable format so the header will be easily interpreted by the server 24. Once at the server 24, the information is preferably decompiled to understand the various pieces of information, and is stored in a file 122 (see FIG. 5) for eventual transmission to some user of the system, as discussed in further detail below.

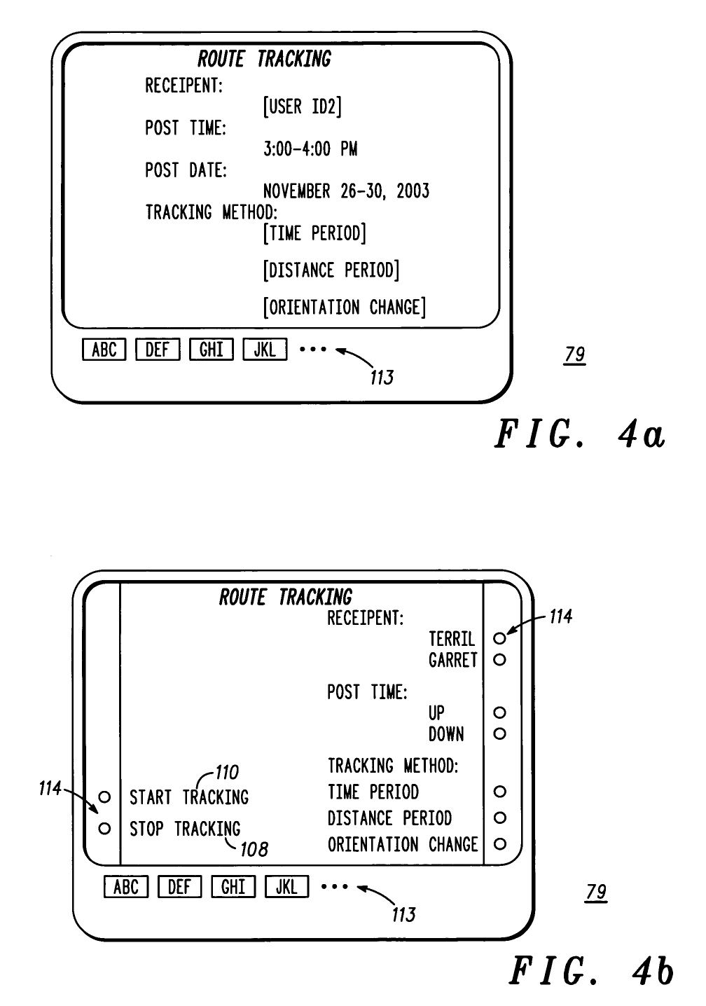

Once the location and identity of a particular user is known, the route-displaying features of this disclosure can be implemented. Returning to the example of FIG. 3, assume the first vehicle 26a decides at point 110 to map the route he is going to travel to the destination 108 for the benefit of the second vehicle 26b. At this point, the user of the first vehicle can use the user interface 51 in his vehicle to start tracking the route. This can be done any number of different ways, as illustrated in FIGS. 4a and 4b. After perhaps the user of the first vehicle 26a engages a menu on his display 79 to enable a route tracking feature, he ultimately is prompted to enter information concerning the intended recipient of the route as shown in FIG. 4a. In this example, the first vehicle 26a user can enter a system user ID for the intended recipient (i.e., the second vehicle—[user ID2]) and other pertinent information concerning the route tracking feature using switches 113 on the user interface 51 in the vehicle, which in this example would be similar to schemes used to enter names and numbers into a cell phone.

As shown in FIG. 4a, the user can also enter or specify other features, such as the date, time, time period at which the route will ultimately be posted to the second vehicle, and/or the date/time at which such posting will expire on the server 24. This is beneficial if the first vehicle 26a knows that the traveled route will have significance to the second vehicle 26b only over a limited time frame. Absent specification by the first user 26a, the posted route can be made to expire at some set time by the server 24. Further details concerning posting times/dates, etc. are disclosed in above-incorporated U.S. patent application Ser. No. [______], entitled “Methods for Sending Messages Based on the Location of Mobile Users in a Communication Network” [Attorney Docket TC00169].

FIG. 4a also shows that the first vehicle can specify the tracking method to be used. For example, once route tracking is engaged, the location information of the first vehicle 26a can be reported to the server on a periodic basis. In this regard, the controller 56 contains or communicates with a clock and also with the odometer through the vehicle bus 60, and therefore knows when a certain time or distance interval has passed. In this regard, the controller 56 can cause the Telematics control unit 40 to transmit location information concerning the first vehicle 26a to the server on that specified (time or distance) periodic basis. Where a periodic distance is reported, the transmitted location information might correspond to the circles 111 in FIG. 3. In another embodiment, the controller 50 of the first vehicle can be made to transmit location information from the navigation unit 62 when the first vehicle 26a substantially changes its heading, trajectory or orientation. Referring briefly to FIG. 2, it is again noted that the head unit 50 contains a positioning unit 66 capable of detecting the first vehicle's heading (deviation from north, etc.), and accordingly the controller 56 can look for significant changes heading (e.g., greater than 30 degree change over a certain time period) and at those times report the location information for the first vehicle, which might correspond to the squares 112 in FIG. 3.

Although it is believed beneficial to start the route tracking process and then have it proceed automatically, in yet another embodiment, the user in the first vehicle 26a may manually prescribe the route locations ultimately transmitted to the second vehicle 26b. In this embodiment, the user in the first vehicle 26a could simply press a button on the user interface to mark his location at random points along the route, such as might denoted by the triangles 113 on FIG. 3. Otherwise, these location data points are treated by the system as are those points that are automatically generated.

Additionally, in the embodiment where a user in the first vehicle 26a can manually press a button along the route to mark location, the user may also couple with each marked location a message such as “turn right” or “go straight through intersection.” The types of messages may be tokens that are preset on the keypad 72 of the user interface 51 or may be audio message recorded simultaneously with the marked location.

The system described above contemplates that specific points along the route are determined and, along with any associated message or data, periodically transmitted to the server 24. In an alternative embodiment, the controller 56 in the head unit 50 may locally store a plurality of points along a route in memory 64, including an associated message or data. When the route is completed by the first vehicle 26a, the controller 56 could then send the plurality of points, along with any associated messages or data, to the server 24 for subsequent use by other users. Furthermore, in another embodiment, the memory 64 may include removable storage media that allows the user of the first vehicle 26a to store points and data along a route and transfer the data to a home personal computer.

FIG. 4b shows an alternative means for entering route tracking information. In this embodiment, multifunction buttons 114 associated with the display 79 are used to enter the user ID of the intended recipient, to adjust the posting time, to choose the tracking method, etc. Default setting such as the user IDs to be displayed can be those that the first vehicle 26a has contacted previously, or which have previously contacted the first vehicle, and retrieved from memory (such as memory 64). Also shown are buttons 114 for starting and stopping the tracking, i.e., which a user in the first vehicle 26a can push at locations 110 (start) and 108 (stop) (FIG. 3).

Once the location data points indicative of the route, the intended recipient and other posting information are entered into the user interface 51 in the first vehicle 26a, such information is sent by the controller 56, via the vehicle bus 60, to the Telematics control unit 40, and ultimately to the server 24. As shown in FIG. 5, the server 24 stores the route information as a series of location points in accordance with the selected tracking method, along with the sending user's system ID code (user ID 1), the recipient's system ID code (user ID2), and other route particulars such as the post/expiration time and date for the message. When wirelessly transmitting to the server 24, the route and its associated information may be formatted in a number of ways. For example, the transmission may constitute a header containing the location data points, the user IDs, the posting data/time, etc., in predictable formats so they will be easily interpreted by the server 24. Once at the server 24, the information is preferably decompiled to understand the various pieces of information, and is stored in a file 122.

As noted above, a vehicle communication system may automatically track the locations of vehicles by virtue of periodic sending of location data from the vehicles to the server 24. Accordingly, it is not necessarily the case that engagement of the route tracking feature using the user interface 51 is the only way to send location data to the server. Indeed, engagement of the route tracking function need not modify the manner in which the vehicle otherwise automatically broadcasts the location data, but instead may simply provide extra information corresponding with that data, such as the user ID of the intended recipient and the times at which route tracking is started and stopped. Moreover, sending of the user ID (or other pertinent tracking information) need not necessarily occur simultaneously with sending of the location data. It is enough that the two (the location data and the user ID) can later be correlated at the server so that the route and its intended recipient are known. In this regard, the idea of sending location data and a user ID to the server 24 should be understood to not necessarily require simultaneous transmission of the two.

At this point, the server 24 may calculate other information which will be useful in eventually getting the route to the second vehicle 26a. For example, in one embodiment, described further below, it may be useful not to display or broadcast the entire route (all location data points) at the second vehicle's 26b user interface 51 at one time. Instead, it may be desired to highlight the route point by point, with each successive point being displayed or broadcast when the second vehicle 26b substantially approaches the immediately preceding point. Accordingly, the server 24, perhaps in accordance with user preferences, may compute an area 125 around each of the route locations (see FIG. 3, showing a few of such areas 125 around the circle locations) posted by the first vehicle 26a to define and store areas, as is shown in FIG. 5. A scheme for doing this are disclosed in above-incorporated U.S. patent application Ser. No. [______], entitled “Methods for Sending Messages Based on the Location of Mobile Users in a Communication Network” [Attorney Docket TC00169], and therefore are not repeated here.

Once the route information is received at the server 24, it is transmitted to the user interface 51 of the second vehicle 26b. This is facilitated because the system, in a preferred embodiment, continually tracks the location and identity of the users connected to it, although this could also be made user selectable. Thus, the server 24 checks to see if the second vehicle 26b (i.e., user ID2) is coupled to the system, and the route information from the first vehicle (user ID1) is transmitted to it. The server 24 may wait to transmit once the first vehicle's route is completed, but in a preferred embodiment, sends location data points to the second vehicle 26 as they become available, which enables the second vehicle to see the route as its being formed, which is useful if the second vehicle is not lagging too far behind the first vehicle.

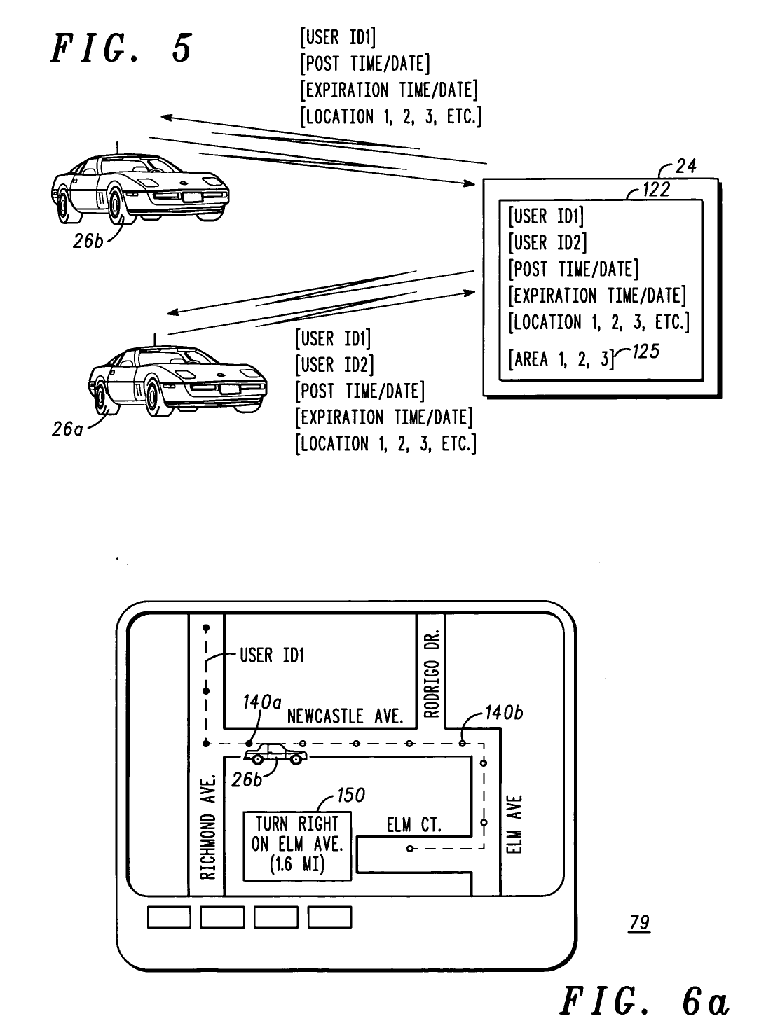

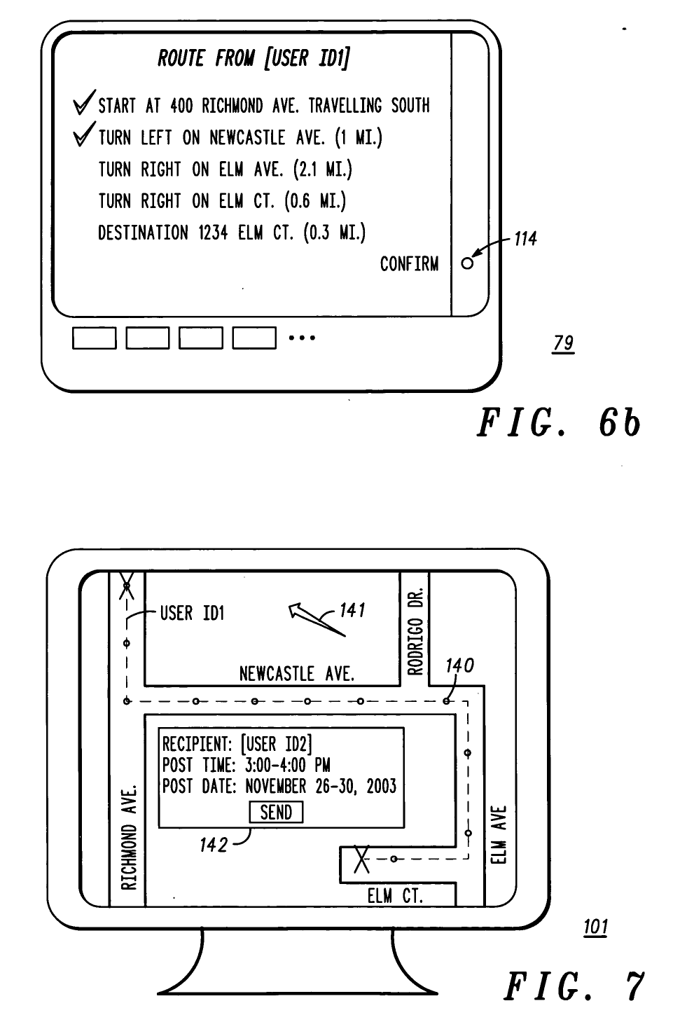

The route information received at the user interface 51 of the second vehicle 26b can be displayed or broadcast in any number of ways. For example, and as shown in FIG. 6a, the data points 140 corresponding the location of the first vehicle (location 1, 2, 3, etc.) can be superimposed on an otherwise-standard navigational mapping system on the user interface's display 79. Such a mapping system can be resident in the memory 64 of the head unit 50 or can be located at the server 24, which could generate an appropriate map and broadcast it to the user. The displayed map may include other helpful items to the second user, such as street names, an icon representing the present location of the second vehicle 26b as shown, etc. Additionally, as the second vehicle 26b is capable of receiving route information from potentially any user of the system, and multiple users at the same time, the displayed route is preferably also labeled with the sending user's ID (user ID1). Again, if specific posting/expiration times, dates, or periods have been specified by the first user, the server 24 broadcasts the route in accordance with those parameters.

It is also preferable for the displayed route to change or update in response to the second vehicle's 26b progress along the route. In one embodiment, and as shown in FIG. 6a, the displayed route points can change as the second vehicle 26b has approached or cleared them. Means for assessing whether such points have been reached or cleared are discussed above with respect to definition of areas 125 as discussed above (see FIG. 3). Thus, as shown, the markers for the points change in visual appearance as they are reached or cleared, turning from hollow circles 140b to filled circles 140a. Of course, many different schemes could be used to effect progress along the route, and the disclosed scheme is merely exemplary. For example, the reached or cleared points could also simply be deleted from the second vehicle's display 79. However, the route could still be stored in memory 64 within the head unit 60 should it later need to be again retrieved by the second user.

The displayed route points need not exactly correspond to the location data (location 1, 2, 3, etc.; see FIG. 5) posted by the first vehicle 26a. Instead, the server 24 (or possibly the head unit 50 in the second vehicle) can generate new points 140 for display at the second user interface using the location data from the first vehicle 26a. This might be beneficial for example if two successive locations left by the first vehicle 26a were too far apart such that they are not helpful in helping the second vehicle 26b navigate a number of turns between those points. In this case, the server 24 or head unit 50, with the assistance of a mapping program, can interpolate between these two points to perhaps generate further points to assist in navigation by the second vehicle 26b. In this regard, when this disclosure refers to sending location data and later receiving that location data, it should be understood that the sent and received location data need not be identical.

Route information transmitted to the second vehicle 26b need not be displayed on a map. For example, as shown in FIG. 6b, the location data, in conjunction with a mapping program such as that discussed above, can translate the route into directions for the second user to follow. Progress along the route can also be displayed, such as by the use of the check symbols as shown. Alternatively, such a route can also be broadcast through the speakers 78 of the user interface in the second vehicle, preferably in advance of a required turn by the second vehicle 26b. Such an audio broadcast of the route may also be accompanied by displaying of other useful information on the display 79. Posting/expiration times, dates, or periods can also be displayed or broadcast at the second vehicle's user interface 51 if desired. Posting of directions can also be used in conjunction with the map of FIG. 6a, as shown by the use of direction window 150, which informs the second vehicle of the next turn it needs to make along the route.

When route information is first transmitted to the second vehicle 26b, some sort of route notification indicator is preferably broadcast to the second user, such as a flashing indicator on the display or an audible cue broadcast through the speakers 79, such as a “beep.” Such an indicator can be selectable by the second user so that the route can be displayed or broadcast at a time that is convenient for the second user. Additionally, the user interface 51 at the second vehicle may require the second vehicle to enter a personal identification code such as a Personal Identification Number (PIN) prior to receiving the route. Such a PIN, like other aspects in the system, can be entered textually, by pressing buttons, or by voice recognition. Upon validation of the PIN at the server 24 (or at the controller 56), the route can be sent by the server 24 to the user interface 51, or if already sent, can be enabled for display or transmission.

Additionally, it is preferable that the second user provide some sort of confirmation to the server 24 and/or the first user that the route has been received. Such confirmation can come in many different formats. The second user can press a confirmation button 114 on his user interface 51 as shown in FIG. 6b, at which point the server logs such confirmation and perhaps transmits the same to the first vehicle 26a so that the first user can know that his route has been received and/or is being followed. Confirmation can also be sent when the second user selects the route notification indicator as just discussed. Or confirmation can come on a point-by-point basis, with separate confirmation coming with each location point that the second user approaches or clears. This style of confirmation would allow the first user to see the progress of the second vehicle 26b along the route. When confirmation is received by the server 24, the route's file may be deleted there, although it can remain stored in the memory 64 of the second vehicle's 26b head unit 50 for some time to allow it again to be reviewed again by the second vehicle if necessary.

In an alternative embodiment, it may additionally be useful for the first vehicle 26a to post a message for the second vehicle 26b in addition to posting of the route. Such messages can be associated with particular points along the route, or may constitute a single message associated generally with the route. Such a message posting technique is disclosed in above-incorporated U.S. patent application Ser. No. [______], entitled “Methods for Sending Messages Based on the Location of Mobile Users in a Communication Network” [Attorney Docket TC00169].

Although in preferred embodiments route information is left in accordance with the location of a traveling vehicle, in an alternative embodiment, route information can be left by a stationary user for the benefit of mobile users. Thus, suppose a home based user wishes to provide a route to the second vehicle 26b, perhaps directions to the home based user's house. Assuming the home based user owns a computer in communication with the system 10, the user can leave a route for the benefit of the second vehicle. One way of doing this is illustrated in FIG. 7, in which the home user uses his home computer to leave a route for the second vehicle 26b. FIG. 7 illustrates the display 101 of the home user's computer, and shows a map of the area encompassing the route. The home user uses a mouse pointer 141 to mark the starting and stopping locations of the route (as designated by Xs), and the computer or the server 24, running an appropriate mapping program, generates the appropriate route, denoted in FIG. 7 by circles 140. The intended receipt user ID and other route particulars are textually entered by the home user in window 142, which can be uploaded to the server 24 (and ultimately the second vehicle 26b) by pressing the “send” button. Further details concerning interaction between a home based user and the system 10 are disclosed in above-incorporated U.S. patent application Ser. No. [______], entitled “Methods for Sending Messages Based on the Location of Mobile Users in a Communication Network” [Attorney Docket TC00169].

To this point, methods for allowing one user (e.g., the first vehicle 26a) to leave route information for another user (e.g., the second vehicle 26b) have been disclosed. However, the disclosed system and methods can also be used to enable a user to leave route information for himself. This is particularly useful in the situation where the user is in an unfamiliar location (such as a business trip) and is therefore prone to getting lost. So posting a route for one's self is not significantly different from posting a route for another as illustrated above, with the exception that the user designates himself as the intended recipient by associating his user ID with the route of interest. Such route information can be useful to the user, who may need to follow the same route (e.g., every morning) or who may need to need to follow the route backwards to find the way back to a certain location, such as his hotel.

Although the disclosed system and method are illustrated as being useful to leave route information with a single system user, it is also possible to leave a single route with numerous users, assuming their user IDs are also specified when the route is posted to the system. Moreover, a posting to a single user can also be associated with a number of routes, a feature which might be useful for example if the recipient can take one of a plurality of route to arrive at a particular location.

While largely described with respect to improving communications within vehicles, one skilled in the art will understand that many of the concepts disclosed herein could have applicability to other portable communicative user interfaces not contained within vehicles, such as cell phones, personal data assistants (PDAs), portable computers, etc., what can be referred to collectively as portable communication devices.

Although several discrete embodiments are disclosed, one skilled in the art will appreciate that the embodiments can be combined with one another, and that the use of one is not necessarily exclusive of the use of other embodiments. Moreover, the above description of the present invention is intended to be exemplary only and is not intended to limit the scope of any patent issuing from this application. The present invention is intended to be limited only by the scope and spirit of the following claims.

1. A method for marking route traveled by a first user having a first user interface and presenting the route to a second user having a second user interface, comprising:
having a first user travel along the route in a first direction;
having the first user interface wirelessly send to a communication network:
a first identification code for the first user,
the present location of the first user at a plurality of times during the route to form a plurality of location data and associated maneuver data, and
an identification code for the second user;
wirelessly sending from the communication network the location data and associated maneuver data to a second user interface in the second vehicle;
presenting the location data and associated maneuver data to the second user at the second user interface to inform the second user of the route of the first user; and
having the second user travel along the route in accordance with the presented location data and associated maneuver data.

2. The method of claim 1, further comprising the step of wirelessly sending to the communication network confirmation when the second user has substantially arrived at at least one of the plurality of location data.

3. The method of claim 2, wherein the arrived-at location data are modified on a display associated with the second user interface.

4. The method of claim 2, wherein the communication network wirelessly sends confirmation to the first user interface that the second user has arrived at at least one of the plurality of location data.

5. The method of claim 1, wherein each of the associated maneuver data includes an associated audio message by the first user, and wherein the step of presenting the plurality of location data to the second user includes playing the associated audio messages to the second user.

6. The method of claim 1, wherein the plurality of location data and associated maneuver data are presented to the second user on a display associated with the second user interface.

7. The method of claim 6, wherein the plurality of location data and associated maneuver data are presented to the second user on a map on the display.

8. The method of claim 1, wherein the plurality of location data are presented to the second user just prior to the second user's arrival at one of the plurality of location data.

9. The method of claim 1, wherein each of the plurality of location data and associated maneuver data are automatically generated when the first user performs a plurality of maneuvers along the route.

10. The method of claim 1, wherein the plurality of times are based on a plurality of maneuvers made by the first user.

11. The method of claim 1, wherein the plurality of times occur when the first user substantially changes its orientation.

12. The method of claim 1, wherein the plurality of times occur when the first user presses a button on the first user interface.

13. The method of claim 1, further comprising the step of sending the first identification code from the communication network to the second user interface.

14. The method of claim 1, wherein when the second user arrives at one of the plurality of locations along the route, a direction to a subsequent one of the plurality of locations is presented by the second user interface.

15. The method of claim 14, wherein the direction is computed by the communication network.

16. The method of claim 14, wherein the direction is computed by a navigation system in communication with the second user interface.

17. The method of claim 1, wherein the second user travels along the route in the same direction as the first user.

18. The method of claim 1, wherein the second user along the route in the opposite direction as the first user.

19. The method of claim 1, wherein all of the plurality of location data are presented to the second user at the second user interface at one time to fully display the first user's route.

20. The method of claim 1, wherein one of the plurality of location data and associated maneuver data is presented to the second user at the second user interface as the second user substantially approaches that location data.

21. The method of claim 1, wherein at least one of the first and second user interfaces is contained within a vehicle.

22. The method of claim 1, wherein at least one of the first and second user interfaces is a portable computer.

23. A method for marking and traveling a route of a first user having a first user interface, comprising:
during a first period of time:
having a first user travel along the route during a first period of time;
using the first user interface to store the present location of the first user at a plurality of times during the route to form a plurality of location data and associated maneuver data;
during a second period of time:
presenting the stored plurality of location data and associated maneuver data at the first user interface; and
having the first user travel along the route in accordance with the presented plurality of location data and associated maneuver data.

24. The method of claim 23, further comprising the step of confirming when the first user has substantially arrived at least one of the plurality of location data during the second period of time.

25. The method of claim 24, further comprising the step of modifying the arrived-at location data from a display associated with the first user interface.

26. The method of claim 23, wherein the plurality of location data and associated maneuver data are presented audibly by the first user interface to the first user.

27. The method of claim 23, wherein the plurality of location data and associated maneuver data are presented to the first user on a display associated with the first user interface.

28. The method of claim 27, wherein the plurality of location data and associated maneuver data are presented to the first user on a map on the display.

29. The method of claim 23, wherein the plurality of location data are presented to the first user just prior to the first user's arrival at one of the plurality of location data.

30. The method of claim 23, wherein each of the plurality of location data and associated maneuver data are automatically generated when the first user performs a plurality of maneuvers along the route.

31. The method of claim 23, wherein the plurality of times are based on a plurality of maneuvers made by the first user.

32. The method of claim 23, wherein the plurality of times occur when the first user substantially changes its orientation.

33. The method of claim 23, wherein the plurality of times occur when the first user presses a button on the first user interface.

34. The method of claim 23, wherein when the first user arrives at one of the plurality of locations along the route during the second period of time, a direction to a subsequent of the plurality of locations is presented by the first user interface.

35. The method of claim 34, wherein the direction is computed by a communication network in wireless communication with the first user interface.

36. The method of claim 34, wherein the direction is computed by a navigation system in communication with the first user interface.

37. The method of claim 23, wherein the first user travels along the route during the second period of time in the same direction as during the first period of time.

38. The method of claim 23, wherein the first user travels along the route during the second period of time in the opposite direction as during the first period of time.

39. The method of claim 23, wherein the first user interface is in wireless communication with a communication network, and wherein the plurality of location data are stored at the communication network during the first period of time, and wherein the plurality of location data are presented to the first user interface from the communication network during the second period of time.

40. The method of claim 23, wherein all of the plurality of location data are presented to the first user at the first user interface at one time to fully display the route of the first user.

41. The method of claim 23, wherein one of the plurality of location data and associated maneuver data is presented to the first user at the first user interface as the first user substantially approaches that location data.

42. The method of claim 23, wherein the first user interface is contained within a vehicle.

43. The method of claim 23, wherein the first user interface is a portable computer.

44. A method for posting a route using a first user interface and presenting the route to a second user having a second user interface, comprising:
having the first user interface wirelessly send to a communication network:
a first identification code for the first user,
a route comprising a plurality of location data and associated maneuver data, and
an identification code for the second user;
wirelessly sending from the communication network the location data to the second user interface;
presenting the location data to the second user at the second user interface to inform the second user of the route; and
having the second user travel along the route in accordance with the presented location data.

45. The method of claim 44, further comprising the step of wirelessly sending to the communication network confirmation when the second user has substantially arrived at at least one of the plurality of location data.

46. The method of claim 45, wherein the arrived-at location data are modified on a display associated with the second user interface.

47. The method of claim 45, wherein the communication network wirelessly sends confirmation to the first user interface that the second user has arrived at at least one of the plurality of location data.

48. The method of claim 44, wherein each of the associated maneuver data includes an associated audio message by the first user, and wherein the step of presenting the plurality of location data to the second user includes playing the associated audio messages to the second user.

49. The method of claim 44, wherein the plurality of location data and associated maneuver data are presented to the second user on a display associated with the second user interface.

50. The method of claim 49, wherein the plurality of location data and associated maneuver data are presented to the second user on a map on the display.

51. The method of claim 44, wherein the plurality of location data are presented to the second first user just prior to the second user's arrival at one of the plurality of location data.

52. The method of claim 44, wherein each of the plurality of location data and associated maneuver data are automatically generated when the first user performs a maneuver along the route.

53. The method of claim 44, further comprising sending the first identification code from the communication network to the second user interface.

54. The method of claim 44, wherein when the second user arrives at one of the plurality of locations along the route, a direction to a subsequent one of the plurality of locations is presented by the second user interface.

55. The method of claim 54, wherein the direction is computed by the communication network.

56. The method of claim 54, wherein the direction is computed by a navigation system in communication with the second user interface.

57. The method of claim 44, wherein all of the plurality of location data and associated maneuver data are presented to the second user at the second user interface at one time to fully display the route.

58. The method of claim 44, wherein one of the plurality of location data is presented to the second user at the second user interface as the second user substantially approaches that location data.

59. The method of claim 44, wherein at least one of the first and second user interfaces is contained within a vehicle.

60. The method of claim 44, wherein at least one of the first and second user interfaces is a portable computer.

61. The method of claim 44, wherein the first user interface comprises a computer in communication with the communication network.
